(19) United States
(12) Patent Application Publication
(10) Pub. No.: US 2011/0020491 A1
(43) Pub. Date: Jan. 27, 2011

(54) REDUCED STUCK ALCOHOLIC FERMENTATIONS IN WINE PRODUCTION

(75) Inventors: Johannes Maarten Van Den Brink, Herlev (DE); Kristine Bjerre, Copenhagen (DK)

Correspondence Address: FOLEY AND LARDNER LLP;SUITE 500, 3000 K STREET NW, WASHINGTON, DC, 20007, US

(73) Assignee: CHR-HANSEN A/S

(21) Appl. No.: 12/864,560

(22) PCT Filed: Dec. 22, 2008
(86) PCT No.: PCT/EP08/68149

§ 371 Date: Oct. 14, 2010

(30) Foreign Application Priority Data
Jan. 29, 2008 (EP) 08101058.9

(51) Int. Cl. C12G 1/022

(52) U.S. Cl. 426/13

(57) ABSTRACT

A method for production of a wine wherein the method significantly decreases the risk of unwanted stuck alcoholic fermentations. The method involves addition of glucose isomerase to the grape juice.

### FIELD OF THE INVENTION

The present invention relates to a method for production of a wine wherein the method significantly decreases the risk of unwanted stuck alcoholic fermentations. The method involves addition of glucose isomerase to the grape juice.

### BACKGROUND ART

It is known to the skilled person that a glucose/fructose ratio significantly different from 1:1 of grape juice during wine production may result in stuck alcoholic fermentations, i.e. the yeast is not fermenting all the sugar and it may therefore result in a too sweet wine.

This may be a significant problem for industrially relevant wine production.

To the knowledge of the present inventors no really good industrially relevant solution to this stuck alcoholic fermentation problem is presently available.

### SUMMARY OF THE INVENTION

The problem to be solved by the present invention is to provide a new method for production of a wine, wherein the method significantly decreases the risk of unwanted stuck alcoholic fermentations.

The solution is based on that the present inventors found that addition of glucose isomerase to the grape juice helped to maintain the ratio glucose/fructose in the grape juice at a ratio around 1:1, which significantly decreases the risk of unwanted stuck alcoholic fermentations. For further details, see working examples herein.

As mentioned above, it is known to the skilled person that a glucose/fructose ratio of grape juice significantly different from 1:1 may result in stuck alcoholic fermentations, i.e. the yeast is not fermenting all the sugar and it may therefore result in a too sweet wine.

In relation to the method as described herein is glucose isomerase EC 5.3.1.5 (official name Xylose isomerase). The official name for this EC 5.3.1.5 class is xylose isomerase. However, as known to the skilled person as an alternative name it may also be called glucose isomerase. Glucose isomerase is for instance the name used in relevant commercial products of this enzyme class, such as e.g. the commercial product used in working examples herein.

The herein relevant and well known reaction catalyzed by glucose isomerase in the grape juice is following:

D-glucose<=>D-fructose.

As known to the skilled person this enzyme class may also catalyze the reaction:

D-xylose<=>D-xylulose.

This xylose related reaction is less relevant herein.

Before the yeast alcohol fermentation has started, the grape juice used for wine production generally has a glucose/fructose ratio of around 1:1.

It is known to the skilled person that yeast “prefers” glucose over fructose during the wine yeast alcohol fermentation. Said in another way, the glucose may preferably first be metabolized by the yeast and this may result in a glucose/fructose ratio lower than 1:1 in the grape juice.

One theory for the herein described positive effect of using glucose isomerase is that the glucose removed by e.g. the yeast during alcohol fermentation may create a situation in the grape juice, where the glucose/fructose ratio gets lower than 1:1 (one gets “too much” fructose−“too little” glucose). The glucose isomerase equilibrium is then consequently “forced” to the left=>fructose is converted to glucose to “recover” the glucose/fructose ratio of 1:1=>significantly reducing the risk of stuck alcoholic fermentations.

Before yeast alcoholic fermentation O₂ is present in the unfermented grape juice. As known to the skilled person, normal yeast fermentation generally consists of two parts:

Part 1

Aerobic Growth (Oxygen is Present)
This is the initial rapid growth process where the yeast doubles its cell number roughly every 4 hours. (Usually 24-72 hours)

Part 2

Anaerobic Fermentation (No Oxygen Present)
Slower activity and the yeast ferments sugar (both glucose and fructose), converting it to alcohol (sugar=>2 ethyl alcohol+2 CO₂) rather that increasing the number of yeast cells. (This process can take from days to weeks depending on the yeast and the recipe).

Accordingly, during the yeast fermentation the O₂ will sooner or later disappear. However, the glucose isomerase is active with or without the presence of O₂ and can therefore work both before the actual start of the alcohol yeast fermentation or during the actual alcohol yeast fermentation.

Accordingly, a first aspect of the invention relates to a method for production of a wine, which comprises the following steps:
(1): treating grape juice during the alcohol yeast fermentation with an effective amount of glucose isomerase to maintain the glucose/fructose ratio closer
to 1:1 in the grape juice; and thereafter,
(2): further adequate steps to produce the wine of interest.

As shown herein glucose isomerase is relatively stable during normal wine production conditions. Accordingly, the effective amount of glucose isomerase may be added before the actual start of the alcohol yeast fermentation and it will then still work satisfactory during the alcohol yeast fermentation. See working example herein, where it is added to unfermented grape juice.

Alternatively, the effective amount of glucose isomerase may be added during the alcohol yeast fermentation. If it is added during the alcohol yeast fermentation it is preferably done in the beginning of the fermentation, e.g. at roughly the same time as the yeast is added to the grape juice.

### DEFINITIONS

All definitions of herein relevant terms are in accordance of what would be understood by the skilled person in relation to the herein relevant technical context.

The term “maintain the glucose/fructose ratio closer to 1:1” of step (1) of first aspect in relation to treatment of the grape juice with an effective amount of glucose isomerase may be seen as directly relating to using an effective amount of the glucose isomerase. As explained above, the herein relevant function of the glucose isomerase is to try to “reestablish” the glucose/fructose ratio of 1:1. Accordingly, by addition of glucose isomerase as described herein one automatically get closer to 1:1 ratio in the grape juice as described herein.

Embodiment of the present invention is described below, by way of examples only.

### DETAILED DESCRIPTION OF THE INVENTION

### Glucose Isomerase

The glucose isomerase to be used in a method as described herein may be obtained from numerous different suitable sources such as relevant commercially available enzyme products.

As known to the skilled person there are numerous different commercially available glucose isomerase enzyme products on the market with enzymes that work within the normal conditions of winemaking (e.g. relevant pH values, temperature etc).

In the working examples below the following commercially available enzyme product was used:
glucose isomerase: Product from Sigma (# G4166-50 g). Catalogue number—see a working example herein.

### Preferred Production Parameters—Step 1 of First Aspect

As known to the skilled person, changes in the winemaking procedures alter the organoleptic properties of the wine product. Therefore, the close-fit between the usual winemaking procedures and practice of the method as described herein is preferred. Insofar as possible, nothing is done through practice of this invention to alter taste and bouquet of the wine.

Essentially, the skilled winemaker should preferably not change anything in his preferred winemaking process, except the addition of glucose isomerase as described herein.

For example, enzyme catalyzed processes are usually conducted within the pH optimum of the enzyme. Preferred practice of this invention is to treat unfermented grape juice without adjusting the pH thereof. Fortunately, suitable relevant commercial available products of the enzymes as used herein exhibit adequate activity and stability in herein relevant steps of the winemaking process.

It is to be understood that any enzyme as described herein can be used in the method according to the invention, provided that it exhibits a reasonable relevant activity and stability at the pH and temperature prevailing during the method for producing wine. Thus, both soluble and immobilized enzyme preparations may be used, even if soluble enzyme preparations are usually preferred.

In a preferred embodiment the relevant enzyme preparation(s) is a solid water soluble preparation, preferably a non-dusting preparation. The storage stability of a solid preparation is better than the storage stability of a liquid preparation, and also, it is unnecessary to add any conservation agents. It is recommended, though, that the user dissolve the solid form agent in a small amount of water immediately before use.

It is easy for the worker skilled in the art to find out how much enzyme of a given kind is needed for a given juice.

For instance, depending on the details of treatment times and temperatures:
(ii): a glucose isomerase activity roughly between about 100 and 5,000,000 international units per hl of grape juice will be appropriate.

As known to the skilled person an international unit is defined as that amount of the enzyme that catalyses the conversion of 1 micro mole of substrate per minute. The conditions also have to be specified. As known to the skilled person one usually takes a temperature of 30° C. and the pH value and substrate concentration that yield the maximal substrate conversion rate.

Herein the international units are defined as described above and according to the art, i.e. determined at a temperature of 30° C. and the pH value and substrate concentration that yield the maximal substrate conversion rate.

As known to the skilled person it is routine work for the skilled person to determine international units for the enzymes as described herein and it may be determined within a herein relatively minor uncertainty.

For instance, as known to the skilled person, the optimal pH value and optimal substrate concentration may vary for a specific enzyme of interest (e.g. a specific glucose isomerase). However, it is easy to identify this optimal pH and substrate concentration since it is e.g. generally given on the product documentation for a relevant commercial enzyme product. Further, in general for a specific enzyme of interest it is routine work to identify parameters such as optimal pH and substrate concentration.

In a preferred embodiment there is used:
(i): a glucose isomerase activity roughly between about 5,000 and 500,000 international units per hl of grape juice will be appropriate.

In a preferred embodiment the effective amount for the glucose isomerase enzyme during step (1) is so that:
(A): at the end of yeast alcohol fermentation is the sugar content in the grape juice less than 4 g/l, more preferably less than 1 g/l and even more preferably less than 0.1 g/l.

In working example 2, table II herein it can be seen that addition of glucose isomerase resulted in no measurable (“0”) sugar in the grape juice after fermentation—in other words addition of glucose isomerase virtually completely prevented unwanted stuck fermentation. As understood by the skilled person, if there is stuck fermentation yeast will not use all the sugar and there will be a significant amount of sugar left in the grape juice at the end of yeast alcohol fermentation.

Said in other words, if there is as little sugar left as specified under point (A) above it means there has been no significant unwanted stuck fermentation.

Due to the fact that the aroma, the taste and the bouquet of the wine are properties which are extremely sensitive, it could not be predicted whether the lower alcohol wine produced according to the invention would possess wanted properties, in as much as the lower alcohol wine produced according to the invention, with soluble isomerase preparations, will contain traces of inactive isomerase and may differ from ordinary wine in regard to the concentration of other constituents, too. However, it has been found that the lower alcohol wine produced according to the invention possesses all normal properties of wine, including taste and bouquet, except, of course, properties related directly to the alcohol concentration.

### Preferred Production Parameters—Step 2 of First Aspect

Conduct of step 2 of first aspect, i.e., further adequate steps to produce the wine of interest is an obligatory step of the method of the invention. However, no detailed discussion of this step needs to be provided here since conduct of conventional winemaking practices are contemplated expressly and those practices are well known to persons skilled in art of enology (oenology).

For instance, these further adequate steps may be a relevant storage step.

Wine with Lower Content of Alcohol—Extra Addition of Glucose Oxidase

Due to global warming grapes worldwide contain more sugar. This sugar is converted to alcohol in the alcoholic fermentation, resulting in wines with increased alcohol levels.

In U.S. Pat. No. 4,675,191 (Novo Industri, Denmark—published 1987) a method for reducing alcohol content in wine that involves use of the enzyme glucose oxidase is described. With respect to the described method column 2, lines 25-29 read:
“The method of this invention comprises treating unfermented grape juice with glucose oxidase in the presence of oxygen, thereby converting glucose in the grape juice into gluconic acid and thereafter fermenting the so-treated grape juice.”

Accordingly, U.S. Pat. No. 4,675,191 describes that glucose oxidase may remove some glucose from the unfermented grape juice. Less sugar in the grape juice implies less alcohol content in the final wine.

Glucose oxidase has been used in some of the working examples herein in order to make a wine with lower content of alcohol. From these examples it can clearly be seen that presence of glucose isomerase as described herein significantly improves a wine process involving the use of glucose oxidase to lower the content of alcohol.

One reason for glucose isomerase related improvement is that glucose isomerase significantly reduces the stuck fermentation as discussed herein (see e.g. examples 2 and 3 herein).

Accordingly, in an embodiment of the first aspect before the start of the alcohol yeast fermentation of step (1) of the first aspect the following step is made:
(A): treating unfermented grape juice with an effective amount glucose oxidase in the presence of oxygen for a period of time adequate to convert at least a portion of the glucose in the grape juice into gluconic acid.

The addition of glucose oxidase of step (A) may essentially be done as described in U.S. Pat. No. 4,675,191. In fact the winemaker will generally not change anything of relevance to normal practice—except addition of the glucose oxidase.

Glucose oxidase (EC 1.1.3.4) catalyzes following reaction in the grape juice:

Beta-D-glucose+O₂<=>D-glucono-1,5-lactone+H₂O₂

Within the grape juice is the generated “D-glucono-1,5-lactone” spontaneously converted into gluconic acid. Accordingly, D-glucono-1,5-lactone is removed and the equilibrium is therefore going to the right=>glucose is removed from the grape juice.

If the enzyme preparation also has catalase activity the created H₂O₂ is also removed=>equilibrium is therefore going even more to the right=>more glucose is removed. Involvement of catalase activity is a preferred embodiment herein. Catalase (EC 1.11.1.6) catalyzes the reaction:

2H₂O₂<=>O₂+2H₂O

If glucose oxidase is used as described in step (A) above, it is preferred that glucose isomerase is added together with the glucose oxidase to the unfermented grape juice. This is done in a working example herein with very positive results. Below is discussed preferred embodiment in relation to this step (A) of treating unfermented grape juice with an effective amount glucose oxidase.

One theory for that a combined use of glucose oxidase and isomerase may remove a significant part of glucose is following. The glucose removed by the glucose oxidase creates a situation in the grape juice, where the glucose/fructose ratio gets lower than 1:1 (one gets “too much” fructose−“too little” glucose). The glucose isomerase equilibrium is consequently “forced” to the left=>fructose is converted to glucose to “recover” the glucose/fructose ratio of 1:1=>the glucose oxidase get “newly” created glucose to work on and thereby globally more sugar is removed (both glucose and fructose) from the grape juice. As discussed above, the maintenance of the glucose/fructose ratio of 1:1 also has the advantage of significantly reducing the risk of stuck alcoholic fermentations.

The glucose oxidase to be used in a method as described herein may be obtained from numerous different suitable sources such as relevant commercially available enzyme products.

As known to the skilled person there are numerous different commercially available glucose oxidase enzyme products on the market with enzymes that works within the normal conditions of winemaking (e.g. relevant pH values, temperature etc).

In the working examples below were used following commercially available enzyme products:
glucose oxidase: Hyderase® (from Amano).

An advantage of the Hyderase® product is that is also comprises catalase activity.

It is easy for the worker skilled in the art to find out how much enzyme of a given kind is needed for a given juice and a desired sugar conversion.

For instance, depending on the details of treatment times and temperatures:
(i): a glucose oxidase activity roughly between about 1,000 and 50,000,000 international units per hl of grape juice will be appropriate.

In a preferred embodiment there is used:
(i): a glucose oxidase activity roughly between about 15,000 and 5,000,000 international units per hl of grape juice.

In a preferred embodiment the effective amount and the period of time for the two glucose oxidase/isomerase enzymes during step (A) is so that:
(A): the sugar content in the grape juice is reduced by at least 10%, more preferably at least 14% and even more preferably at least 17%.

As discussed above, in working examples herein the sugar content (both glucose and fructose) was reduced by 19%.

### EXAMPLES

### Example 1

### Enzymatic Sugar Reduction in Grape Juice—Example of Step (1) of First Aspect

One possible way to reduce the final alcohol content in wine is to reduce the sugar concentration in the grape juice before the alcoholic fermentation. Therefore an enzymatic treatment of the grape juice was performed in order to reduce the total sugar content.

Three independent experiments were performed using two replicates in each case. In each sample 200 ml grape juice (Pinot Blanc 2007, Germany, pasteurized) was added to a glass flask and continuously mixed with a magnetic stirrer. The samples were aerated throughout the experiment.

Either 100 mg glucose oxidase (Hyderase, Amano, >15,000 u/g) or both 100 mg glucose oxidase and 1 g glucose isomerase (Sigma, G4166-50 g, >350 u/g) were added to the flasks. The incubation was allowed to run at room temperature for 3 days.

Samples were taken just before addition of the enzymes and after 3 days. Samples were analyzed for the presence of glucose and fructose using a commercial UV based assay supplied by Boehringer Mannheim/R-biopharm (catalog number 10 139 106 035) following the protocol provided by the manufacturer. The results of this experiment are summarized in Table I below.

TABLE I
Enzymatic sugar (glucose and fructose) reduction in grape juice.

| | | total sugar | Reduction total |
|---|---|---|---|
| Day | Treatment | (g/l) | sugar (%) |
| 0 | GOX | 230 | 0 |
| | GOX + isomerase | 235 | 0 |
| 3 | GOX | 202 | 12 |
| | GOX + isomerase | 190 | 19 |

GOX = glucose oxidase

### Conclusion

These results of this example 1 show that a process only using glucose oxidase gave a total sugar reduction of around 12% and extra addition of glucose isomerase significantly increased this to a sugar reduction of around 19%. Less sugar in the grape juice implies less alcohol content in the wine.

### Example 2

### Yeast Fermentation of Treated Grape Juice—Example of Both Step (1) and Step (2) of First Aspect

A full simulation of a general winemaking process was done at laboratory scale. In this experiment it was shown that the enzymatic treatment did have an effect on the final alcohol level without negatively influencing major wine production parameters like the alcoholic fermentation or the malolactic fermentation. The complete experiment was carried out at room temperature, approximately 22° C. Six experiments were performed with each four liters of grape juice (Pinot Blanc 2007, Germany, pasteurized) in fermentation flasks. The pH of the grape juice was not adjusted and no material was added other than the enzymes described in this example.

The grape juice was preincubated for three days with enzymes as described below, followed by the alcoholic fermentation of 11 days and a malolactic fermentation of 10 days.

### Enzymatic Treatment

The six flasks were divided in three groups of two flasks.

The grape juice in group 1 was preincubated for three days with 0.5 g/l glucose oxidase (Hyderase, Amano, >15,000 u/g), the grape juice in the second group with 0.5 g/l glucose oxidase and 2 g/l Glucose Isomerase (Sigma, G4166-50 g, >350 u/g) and the grape juice in the control group was not treated with enzymes. Following enzyme addition, the flasks were vigorously aerated for three days in the presence of the enzymes, before the alcoholic fermentation was started. Aeration is important since oxygen is required in the glucose oxidase mediated enzymatic conversion.

### Alcoholic Fermentation

The alcoholic fermentation was started by inoculation with rehydrated of freeze dried wine yeast (Saccharomyces cerevisiae Merit. Ferm, Chr. Hansen, 0.1 g/l) to a final concentration of 9E+05 CFU/ml. Rehydration was performed in peptone water (15 g/l Tryptone, Oxoid L 42.9 g/l NaCl, 1.14 g/12% antifoam 1510, BHD 63215) for 10 minutes at room temperature.

At this point the aeration was stopped and the process became depleted for oxygen during the following days as a result of the yeast metabolism. The alcoholic fermentation was allowed to run for eleven days at room temperature which resulted in almost complete conversion of all sugar to alcohol.

### Malolactic Fermentation

Following the alcoholic fermentation, the malolactic fermentation was started. The aim of this part of the process is to convert malate into lactate which results in a more pleasant sensoric sensation and thus is an important part of the wine producing process. The malolactic fermentation is mostly performed by the bacteria Oenococcus oeni. It would be highly undesirable if growth of O. oeni would be impaired by the enzymatic treatment of the grape juice.

Eleven days after the start of the alcoholic fermentation the malolactic fermentation was started by addition of O. oeni (Viniflora, Chr. Hansen. Batch no.: 2711097) to the fermented grape juice. Freeze dried O. oeni (0.7 g of 8.2 E+11 CFU/g) was allowed to rehydrate for 10 minutes in 100 ml of peptone water 15 g/l Tryptone, Oxoid L42, 9 g/l NaCl, 1.14 g/12% antifoam 1510, BHD 63215). Three ml was added to 4000 ml of fermented grape juice, resulting in a final concentration of 4.3*10⁶ CFU/ml. This was allowed to stand for another 10 days at room temperature.

### Results

### Effect of Enzymatic Treatment on Alcohol Levels

Glucose and fructose levels were measured using a commercial UV based assay supplied by Boehringer Mannheim/R-biopharm (catalog number 10 139 106 035), using the protocol supplied by the provider.

TABLE II
sugar levels at the start end of the alcoholic fermentation.

| | | Glucose | Fructose | Total sugar |
|---|---|---|---|---|
| day | Treatment | (g/l) | (g/l) | (g/l) |
| 0 | Control | 110 ± 3 | 118 ± 1 | 229 ± 4 |
| | GOX | 96 ± 5 | 124 ± 3 | 225 ± 9 |
| | GOX + Isomerase | 106 ± 22 | 119 ± 5 | 225 ± 25 |
| 11 | Control | 0 ± 0 | 8 ± 2 | 8 ± 2 |
| | GOX | 24 ± 17 | 59 ± 11 | 83 ± 27 |
| | GOX + Isomerase | 0 | 0 | 0 |

Alcohol was measured at different days during the alcoholic fermentation using the Dr. Rebelein titration method as described in the literature (Bestimmung des alkoholgehalts nach Dr. Rebelein. Issued by: C Schliesmann Kellerie-Chemie GmbH & Co. KG, Auwiesenstrasse 5, 74523 Schwabische Hall (2001)). In the untreated grape juice the fermentation was almost complete, reaching a final alcohol level of 12.7% at the end of the process. When the juice was pretreated with both glucose oxidase and glucose isomerase the sugar fermentation was complete but still the final level of alcohol was significantly lower (11.8%).

The low levels of alcohol found when the juice was pretreated with glucose oxidase only, are a result of incomplete fermentation. The glucose oxidase treated juice in this experiment is not usable in normal winemaking due to the high levels of rest sugar—especially fructose—at the end of fermentation (Table II).

Accordingly, the extra addition of glucose isomerase helped to maintain the ratio glucose/fructose in the grape juice at a ratio around 1:1, which significantly decreases the risk of unwanted stuck alcoholic fermentations as shown when using only GOX.

Further, the experiment with isomerase removed all sugar while still some fructose sugar (8 g/l) was present in the control (untreated grape juice). This demonstrates that isomerase as such prevent stuck fermentations.

TABLE III
alcohol levels during the fermentation.

| Day | Treatment | Alcohol (vol %) |
|---|---|---|
| 0 | Control | 0 |
| | GOX | 0 |
| | GOX + Isomerase | 0 |
| 7 | Control | 10.9 ± 0.3 |
| | GOX | Nd |
| | GOX + Isomerase | 10.7 ± 0.5 |
| 11 | Control | 12.3 ± 0.1 |
| | GOX | 7.5 ± 1.3 |
| | GOX + Isomerase | 11.7 ± 0.1 |
| 16 | Control | 12.7 ± 0.1 |
| | GOX | 9.3 ± 0.6 |
| | GOX + Isomerase | 11.8 ± 0.01 |

At day 11 the malolactic fermentation was started. The alcohol levels in the glucose oxidase (GOX) pretreated samples are in italics to indicate that these values are the result of a severely delayed alcoholic fermentation. Nd: not determined

### CONCLUSION

The results of this example 2 shows that GOX+Isomerase significantly lowered alcohol percentage to 11.8% as compared to 12.7 of control.

Further, the extra addition of glucose isomerase helped to maintain the ratio glucose/fructose in the grape juice at a ratio around 1:1, which significantly decreases the risk of unwanted stuck alcoholic fermentations as compared to using GOX alone.

The low levels of alcohol (9.3%) found when the juice was pretreated with glucose oxidase only, are a result of incomplete fermentation—in other words unwanted stuck alcoholic fermentations. The glucose oxidase treated juice in this experiment is not usable in normal winemaking due to the high levels of rest sugar—especially fructose—at the end of fermentation (Table II).

Further, the experiment with isomerase removed all sugar while still some fructose sugar (8 g/l) was present in the control (untreated grape juice). This demonstrates that isomerase as such prevents stuck fermentations.

### Example 3

### Growth of Yeast During the Alcoholic Fermentation—Addition of Isomerase Significantly Reduces Stuck Alcoholic Fermentation

It is known to the skilled person that stuck fermentations typically arise when fructose concentrations are considerably higher than glucose concentrations. During the alcoholic fermentation the glucose/fructose ratio, which is 1:1 at the start of the alcoholic fermentation, may change to a negative value, resulting in a delayed fermentation.

In this example 3a delayed (stuck) fermentation was induced by treatment of the must with Glucose oxidase alone.

In order to investigate the effect of glucose isomerase on the ability of yeast to grow and survive during an alcoholic fermentation a simulated wine production was performed as described in Example 2 herein. The grape juice was preincubated for three days with enzymes as described below, followed by the alcoholic fermentation of 11 days and a malolactic fermentation of 10 days.

Three independent experiments were performed using two replicates in each case. In each sample 200 ml grape juice (Pinot Blanc 2007, Germany, pasteurized) was added to a glass flask and continuously mixed with a magnetic stirrer. The samples were aerated throughout the experiment.

Either 100 mg glucose oxidase (Hyderase, Amano, >15,000 u/g) or both 100 mg glucose oxidase and 1 g glucose isomerase (Sigma, G4166-50 g, >350 u/g) were added to the flasks. The incubation was allowed to run at room temperature for 3 days. After this time point the alcoholic fermentation was started by inoculation with re-hydrated freeze dried wine yeast (Saccharomyces cerevisiae Merit. Ferm, Chr. Hansen, 0.1 g/l) to a final concentration of 9E+05 CFU/ml. Rehydration was performed in peptone water (15 g/l Tryptone, Oxoid L 42.9 g/l NaCl, 1.14 g/12% antifoam 1510, BHD 63215) for 10 minutes at room temperature. Eleven days after the start of the alcoholic fermentation the malolactic fermentation was started by addition of O. oeni (Viniflora, Chr. Hansen. Batch no.: 2711097) to the fermented grape juice. Freeze dried O. oeni (0.7 g of 8.2 E+11 CFU/g) was allowed to re-hydrate for 10 minutes in 100 ml of peptone water 15 g/l Tryptone, Oxoid L 42.9 g/l NaCl, 1.14 g/12% antifoam 1510, BHD 63215). Three ml was added to 4000 ml of fermented grape juice, resulting in a final concentration of 4.3*10⁶ CFU/ml. This was allowed to stand for another 10 days at room temperature.

The number of S. cerevisiae colony forming units was determined at a different time point by taking samples from the fermented grape juice and plating serial dilutions on YGC solid medium agar plates followed by an overnight incubation at 30° C.

Sugar levels were determined using a commercial UV based assay supplied by Boehringer Mannheim/R-biopharm (catalog number 10 139 106 035), using the protocol supplied by the provider.

### Results

### Effect of Isomerase on a Stuck Alcoholic Fermentation

During the alcoholic fermentation the sugars in the grape juice are converted to ethanol by the yeast S. cerevisiae.

Treatment with glucose oxidase alone was shown to result in a delayed alcoholic fermentation (stuck fermentation) due to delayed growth of S. cerevisiae (as shown in Table IV). In the must pretreated with glucose oxidase, growth of yeast was very poor during the first days of the alcoholic fermentation. The number of CFUs was below the detection limit at day 1 and was approximately 3 log units lower at day 2 of the alcoholic fermentation. This is a clear indication of a stuck fermentation.

This result was supported by the sugar analysis. While in the non-treated must approx. 60% of the sugar was fermented after 3 days of yeast fermentation, less than 10% was fermented in the GOX pre-treated must.

However, when glucose isomerase was present during the pre-treatment and alcoholic fermentation, the fermentation process behaved almost identical to the fermentation of untreated must. Both the remaining sugar levels and the S. cerevisiae CFU numbers (Table IV) were comparable to the untreated must. In other words; glucose isomerase was able to overcome the stuck fermentation caused by GOX treatment.

TABLE IV
Viable S. cerevisiae cell count during the alcoholic fermentation.

| | | | Total sugar |
|---|---|---|---|
| Days | Treatment | CFU/ml (average) | (g/l) |
| 0 | Control | 7.0±1.4E+05 | 229 ± 4 |
| | GOX | 9.0±4.2E+05 | 225 ± 9 |
| | GOX + Isomerase | 9.0±1.4E+05 | 225 ± 25 |
| 1 | Control | 6.5±2.1E+05 | |
| | GOX | Nd | |
| | GOX + Isomerase | 1.0±0.9E+06 | |
| 2 | Control | 2.2±0.2E+07 | 212 ± 6 |
| | GOX | 5.0±7.1E+04 | 220 ± 6 |
| | GOX + Isomerase | 1.1±0.9E+07 | 209 ± 11 |
| 3 | Control | 6.9±0.9E+07 | 86 ± 64 |
| | GOX | 2.7±3.3E+06 | 207 ± 5 |
| | GOX + Isomerase | 5.1±1.7E+07 | 96 ± 80 |
| 7 | Control | 3.1±0.9E+07 | 22 ± 10 |
| | GOX | 3.2±1.1E+07 | 141 ± 55 |
| | GOX + Isomerase | 4.3±0.3E+07 | 11 ± 8 |
| 9 | Control | 2.7±0.2E+07 | |
| | GOX | 2.0E±0.8+07 | |
| | GOX + Isomerase | 1.1±1.6E+07 | |
| 16 | Control | 6.9±6.6E+06 | 2 ± 1 |
| | GOX | 2.9±1.0E+06 | 53 ± 12 |
| | GOX + Isomerase | 9.5±9.2E+05 | 0 ± 0 |
| 18 | Control | 2.5±0E+05 | |
| | GOX | 4.0±2.1E+06 | |
| | GOX + Isomerase | 2.0E+05 | |

The grape juice had been pre-treated for three days as described. Yeast was added at t = 0 days. Nd = below detection limit.

### Conclusion

As shown in this example 3 use of GOX alone may induce significant unwanted stuck fermentation.

The results of this example 3 show that addition of isomerase can help to overcome the negative effects of addition of GOX on the growth of S. cerevisiae generally used for wine production.

### Example 4

### Effect of Glucose Isomerase in Fermentation of Synthetic Grape Juice

In order to investigate the effect of glucose isomerase alone under defined conditions a fermentation of synthetic grape juice was carried out. The grape juice consists of yeast nitrogen base (YNB), tartaric acid and varying amounts of glucose and fructose.

The effect of glucose isomerase is investigated in terms of analyzing the yeast growth and glucose/fructose reduction during the fermentation as well as the ethanol production.

The experiment was carried out in 1 l autoclaved fermentation flasks with 500 ml synthetic grape juice in each and all fermentations were performed in duplicates. The synthetic grape juice media (0.67% YNB, 2.0 g/l tartaric acid, glucose and fructose in different amounts, miliQ water, and pH adjusted with 50% w/w KOH) was inoculated with re-hydrated freeze dried wine yeast (Saccharomyces cerevisiae Merit. Ferm, Chr. Hansen, 0.1 g/l) to a final concentration of 9E+05 CFU/ml.

The enzyme glucose isomerase EC 5.3.1.5 (Sigma G4166, >350 U/g) was added (0.5 g/l) to flasks just before yeast inoculation. The ferments was allowed to run unstirred for 41 days at room temperature (approximately 23° C.). The number of S. cerevisiae colony forming units, and the sugar levels at the given times were determined as described in example 3. The ethanol concentration was measured according to enzymatic UV-method and protocol supplied by Boehringer Mannheim/R-biopharm (cat. no. 10 176 290 035).

TABLE V
Overview of fermentations and expectations

| | | | | | Poten- | |
|---|---|---|---|---|---|---|
| | | | | | tial | |
| | | Start | | GI | alcohol | |
| No | G/F | Ratio | pH | (g/l) | (vol %) | Expectations |
| 1 (a & b) | 130/130 | 1.0 | 3.6 | 0.0 | 14.7 | High ethanol => |
| 2 (a & b) | 130/130 | 1.0 | 3.6 | 0.5 | 14.7 | stuck without GI |
| 3 (a & b) | 100/160 | 0.6 | 3.6 | 0.0 | 14.7 | Hig ethanol + imbal- |
| 4 (a & b) | 100/160 | 0.6 | 3.6 | 0.5 | 14.7 | anced G/F ratio => |
| | | | | | | stuck without GI |
| 5 (a & b) | 60/100 | 0.6 | 3.6 | 0.0 | 9.0 | Imbalanced G/F => |
| 6 (a & b) | 60/100 | 0.6 | 3.6 | 0.5 | 9.0 | stuck without GI |
| 7 (a & b) | 60/100 | 0.6 | 5.0 | 0.0 | 9.0 | Imbalanced G/F => |
| 8 (a & b) | 60/100 | 0.6 | 5.0 | 0.5 | 9.0 | stuck without GI. |
| | | | | | | Raised pH => Better |
| | | | | | | GI activity |
| Control − | 100/100 | 1.0 | 3.6 | 0.0 | 11.2 | “standard” fermen- |
| (a & b) | | | | | | tation without stuck |
| Control + | 100/100 | 1.0 | 3.6 | 0.5 | 11.2 | |
| (a & b) | | | | | | |

### Results

### Effect of Glucose Isomerase in Fermentation of Synthetic Grape Juice.

The fermentation of juices with high sugar levels (total sugar=260 g/l) with both balanced and unbalanced glucose/fructose ratios resulted in stuck fermentations when not treated with glucose isomerase. See table V and VI. This shows that high sugar levels alone can cause stuck fermentation. With the isomerase however the fermentations was much faster and all the sugar was fermented.

TABLE VI
Reduction of glucose and fructose during the alcoholic
fermentation in the first 4 experiments.

| | Aver- | | day | g/L | g/L | g/L | stdev | stdev | stdev |
|---|---|---|---|---|---|---|---|---|---|
| | eage | GI | time | Cglu | Cfruc | Ctotal | glu | fruc | total |
| 1 | 130/130 | − | 0 | 133.9 | 130.0 | 263.8 | 0.0 | 0.6 | 0.6 |
| | pH 3.6 | | | | | | | | |
| 1 | | − | 20 | 2.6 | 22.7 | 25.4 | 0.1 | 3.4 | 3.4 |
| 1 | | − | 30 | 0.4 | 8.5 | 8.9 | 0.1 | 0.9 | 0.9 |
| 1 | | − | 35 | 0.1 | 6.8 | 7.0 | 0.0 | 3.0 | 3.0 |
| 2 | 130/130 | + | 0 | 132.6 | 130.4 | 263.0 | 3.1 | 3.7 | 6.7 |
| | pH 3.6 | | | | | | | | |
| 2 | | + | 20 | 0.1 | 4.4 | 4.5 | 0.0 | 0.6 | 0.6 |
| 2 | | + | 30 | −0.2 | 0.9 | 0.8 | 0.2 | 0.3 | 0.0 |
| 2 | | + | 35 | 0.0 | 0.5 | 0.5 | 0.0 | 0.0 | 0.1 |
| 3 | 100/160 | − | 0 | 102.3 | 157.8 | 260.1 | 1.8 | 1.8 | 0.0 |
| | pH 3.6 | | | | | | | | |
| 3 | | − | 20 | 1.5 | 24.0 | 25.4 | 1.3 | 15.1 | 16.4 |
| 3 | | − | 30 | 0.2 | 11.0 | 11.3 | 0.3 | 9.6 | 9.9 |
| 3 | | − | 35 | 0.1 | 7.9 | 8.0 | 0.1 | 7.6 | 7.8 |
| 4 | 100/160 | + | 0 | 99.7 | 156.9 | 256.7 | 0.6 | 0.6 | 0.0 |
| | pH 3.6 | | | | | | | | |
| 4 | | + | 20 | 0.1 | 4.8 | 4.9 | 0.1 | 3.7 | 3.8 |
| 4 | | + | 30 | 0.0 | 1.0 | 1.1 | 0.0 | 0.7 | 0.7 |
| 4 | | + | 35 | 0.0 | 0.7 | 0.7 | 0.0 | 0.4 | 0.4 |

Yeast inoculation at day t = 0 days.

The set-ups with low and unbalanced sugars (60/100) are supposed to represent production of a wine with a reduced final alcohol concentration. Here the effect of GI is observed at two different pH values: pH 3.6 and pH 5.2 respectively. At elevated pH the enzyme is proved to more active as expected, compare ferments 60/100 with isomerase at pH 3.6, day 6 with pH 5.2, day 6 showing a total of 18 and 5 g/l residual sugar. However the fermentations treated with GI at both pH values are more efficient than the untreated fermentations where it takes 4 more days for the yeast to complete the fermentations.

When testing the effect of glucose isomerase in a more standard like juice with balanced glucose/fructose ratio and a total amount of sugar of 200 g/l the results were more or less the same with improved alcohol fermentation with the enzyme.

TABLE VII
Reduction of glucose and fructose during the
alcoholic fermentation in set-up 5-10.

| | Aver- | | day | g/L | g/L | g/L | stdev | stdev | stdev |
|---|---|---|---|---|---|---|---|---|---|
| | age | GI | time | Cglu | Cfruc | Ctotal | glu | fruc | total |
| 5 | 60/100 | − | 0 | 60.9 | 100.4 | 161.3 | 4.3 | 1.8 | 6.1 |
| | pH 3.6 | | | | | | | | |
| 5 | | − | 6 | 3.3 | 27.3 | 30.7 | 0.3 | 1.2 | 1.5 |
| 5 | | − | 9 | 0.1 | 6.6 | 6.7 | 0.1 | 0.7 | 0.8 |
| 5 | | − | 13 | 0.0 | 0.5 | 0.5 | 0.0 | 0.1 | 0.1 |
| 6 | 60/100 | + | 0 | 59.2 | 100.8 | 160.0 | 3.1 | 6.1 | 9.2 |
| | pH 3.6 | | | | | | | | |
| 6 | | + | 6 | 1.1 | 16.8 | 17.9 | 0.1 | 1.5 | 1.7 |
| 6 | | + | 9 | 0.0 | 0.2 | 0.2 | 0.0 | 0.2 | 0.2 |
| 6 | | + | 13 | 0.0 | 0.1 | 0.1 | 0.0 | 0.0 | 0.0 |
| 7 | 60/100 | − | 0 | 61.7 | 101.3 | 163.0 | 1.8 | 6.8 | 8.6 |
| | pH 5.0 | | | | | | | | |
| 7 | | − | 6 | 5.4 | 33.9 | 39.3 | 2.2 | 6.9 | 9.1 |
| 7 | | − | 9 | 0.2 | 8.8 | 9.0 | 0.1 | 3.0 | 3.2 |
| 7 | | − | 13 | 0.0 | 0.6 | 0.6 | 0.0 | 0.2 | 0.2 |
| 8 | 60/100 | + | 0 | 60.9 | 101.7 | 162.6 | 1.8 | 1.2 | 3.1 |
| | pH 5.0 | | | | | | | | |
| 8 | | + | 6 | 0.2 | 4.7 | 4.9 | 0.1 | 5.9 | 6.0 |
| 8 | | + | 9 | 0.0 | 0.1 | 0.1 | 0.0 | 0.1 | 0.1 |
| 8 | | + | 13 | 0.0 | 0.0 | 0.1 | 0.0 | 0.0 | 0.0 |
| 9 | 100/100 | − | 0 | 99.3 | 98.2 | 197.6 | 3.7 | 3.7 | 7.4 |
| | pH 3.6 | | | | | | | | |
| 9 | Control − | − | 6 | 16.6 | 44.2 | 60.9 | 0.9 | 0.6 | 1.5 |
| 9 | | − | 9 | 3.6 | 20.9 | 24.8 | 0.9 | 0.2 | 1.5 |
| 9 | | − | 13 | 0.2 | 6.5 | 6.7 | 0.1 | 1.4 | 1.6 |
| 9 | | − | 20 | 0.0 | 0.9 | 1.0 | 0.0 | 0.3 | 0.3 |
| 10 | 100/100 | + | 0 | 101.9 | 100.0 | 201.9 | 0.0 | 0.0 | 0.0 |
| | pH 3.6 | | | | | | | | |
| 10 | Control + | + | 6 | 5.5 | 26.6 | 32.1 | 1.3 | 2.5 | 3.7 |
| 10 | | + | 9 | 0.1 | 3.3 | 3.3 | 0.0 | 0.0 | 0.0 |
| 10 | | + | 13 | 0.0 | 0.3 | 0.3 | 0.0 | 0.0 | 0.0 |
| 10 | | + | 20 | 0.0 | 0.2 | 0.2 | 0.0 | 0.0 | 0.0 |

Yeast inoculation at day t = 0 days.

The cell counts of S. cerevisiae supports these data obtained from measuring sugars. During the first two weeks of the fermentation an almost similar growth of yeast is seen in all set-ups, but hereafter the yeasts tend to die out faster in fermentations treated with glucose isomerase. This indicates the fermentations are completed faster when treated with the enzyme.

TABLE VII
Viable CFU counts of S. cerevisiae during alcoholic fermentation.

| | ◯ | | ◯ | | ◯ | |
|---|---|---|---|---|---|---|
| Day | 1 | 2 | 3 | 4 | 5 | 6 |
| 0 | 7.9±0.2E+05 | 8.9±0.1E+05 | 9.4±0.2E+05 | 1.0±0.1E+06 | 8.9±0.2E+05 | 9.6±0.9E+05 |
| 2 | 2.5±0E+07 | 4.6±0.3E+07 | 3.3±1.1E+07 | 4.5±0.7E+07 | 4.9±0.4E+07 | 7.0±0.6E+07 |
| 13 | 2.0±0.2E+07 | 2.6±0.3E+07 | 1.7±0.4E+07 | 2.3±0.7E+07 | 3.4±0.8E+07 | 1.2±0.3E+07 |
| 27 | 7.7±0.7E+06 | 5.9±0E+06 | 8.3±0.8E+06 | 6.6±0.4E+06 | 4.9±3.8E+06 | 2.3±0E+06 |
| 41 | 5.6±1.7E+05 | 1.0±0E+04 | 1.8±1.1E+05 | <1.0±E+04 | 2.5±0.7E+03 | 1.0±0E+03 |

| | ◯ | | ◯ | |
|---|---|---|---|---|
| Day | 7 | 8 | 9 | 10 |
| 0 | 4.8±6.7E+05 | 1.0±0.01E+06 | 8.8±2.0E+05 | 9.7±1.7E+05 |
| 2 | 2.7±2.9E+07 | 3.9±3.9E+07 | 4.6±0.5E+07 | 5.9±0.4E+07 |
| 13 | 3.2±0.2E+07 | 2.6±0.5E+07 | 2.4±1.3E+07 | 2.9±0.6E+07 |
| 27 | 4.6±1.6E+06 | 5.7±6.2E+06 | 9.5±0.7E+06 | 2.0±1.5E+06 |
| 41 | 4.5±3.8E+04 | 2.0±1.9E+04 | 1.0±0.1E+05 | 1.2±0E+05 |

Open symbols (◯) represent experiments without glucose isomerase and closed () symbols represent experiments with the enzyme.
Yeast was added at t = 0 days.

### Conclusion

As shown in example 4 the use of glucose isomerase results in a more efficient alcoholic fermentation and reduces the risk of stuck fermentation considerably. This applies to grape juices with both high and low sugar levels as well as balanced and unbalanced ratios of glucose and fructose.

### REFERENCES

1. U.S. Pat. No. 4,675,191 (Novo Industri, Denmark—published 1987)

1. A method for production of a wine, which comprises following steps:
(1): treating grape juice during the alcohol yeast fermentation with an effective amount of
glucose isomerase to maintain the glucose/fructose ratio closer to 1:1 in the grape juice; and thereafter,
(2): further adequate steps to produce the wine of interest.

2. The method of claim 1, wherein
the effective amount of glucose isomerase is added before the actual start of the alcohol yeast fermentation—i.e. it is added to unfermented grape juice;
or
the effective amount of glucose isomerase is added during the alcohol yeast fermentation, preferably at the beginning of the fermentation, e.g. at roughly the same time as yeast is added to the grape juice.

3. The method of claim 1, wherein the effective amount for the glucose isomerase enzyme during step (1) is so that:
(A): at the end of yeast alcohol fermentation is the sugar content in the grape juice less than 4 g/l.

4. The method of claim 3, wherein the sugar content in the grape juice is less than 0.1 g/l.

5. The method of claim 1, wherein the effective amount of the glucose isomerase enzymes is:
(i): a glucose isomerase activity between 100 and 5,000,000 international units per hl of grape juice.

6. The method of claim 1, wherein there is before the start of the alcohol yeast fermentation of step (1) of claim 1 made following step:
(A): treating unfermented grape juice with an effective amount glucose oxidase in the presence of oxygen for a period of time adequate to convert at least a portion of the glucose in the grape juice into gluconic acid.

7. The method of claim 6, wherein the glucose isomerase is added together with the glucose oxidase to the unfermented grape juice.

8. The method of claim 6, wherein the effective amount of the glucose oxidase enzymes is:
(i): a glucose oxidase activity roughly between about 1,000 and 50,000,000 international units per hl of grape juice.

9. The method of claim 7, wherein the effective amount and the period of time for the two glucose oxidase/isomerase enzymes during step (1) is so that:
(A): the sugar content in the unfermented grape juice is reduced by at least 17%.

10. The method of claim 1, wherein the wine is white wine, red wine, still wine or sparkling wine.
